(19) United States
(12) Patent Application Publication
(10) Pub. No.: US 2006/0106908 A1
(43) Pub. Date: May 18, 2006

(54) Low complexity bit-parallel systolic architecture for computing C+AB, AB, C+AB2 or AB2 over a class of GF (2m)

(75) Inventors: Yeun-Renn Ting, Tao-Yuan (TW); Erl-Huei Lu, Tao-Yuan (TW)

Correspondence Address: NIKOLAI & MERSEREAU, P.A., 900 SECOND AVENUE SOUTH, SUITE 820, MINNEAPOLIS, MN, 55402, US

(73) Assignee: CHANG GUNG UNIVERSITY, Tao-Yuan (TW)

(21) Appl. No.: 10/990,594

(22) Filed: Nov. 17, 2004

(51) Int. Cl. G06F 7/00

(52) U.S. Cl. 708/492

(57) ABSTRACT

A systolic architecture for computing C+AB, AB, C+AB² or AB over a class of GF(2^{m}) free global connection, wherein the A, B and C are the input elements of the GF(2^{m}). The systolic architecture includes an inner product unit and a modular unit. The inner product unit includes m² pieces of U cells and 2m+1 pieces of latch units. Each U cell includes a AND gate, a repulsive (or XOR) gate and three latches. The coefficients Aⱼ, Bⱼ and C_{<2j>} of A, B and C are respectively inputted via the input ends Aⱼ, Sⱼ and C_{<2j>} of U_{0,j}, wherein the <2j> represents 2j modulo m+1. The modular unit includes m XOR gates for computing the modular p(x).

### BACKGROUND OF THE INVENTION

1. Field of the Invention

The present invention relates to a low complexity bit-parallel systolic architecture, and more particularly to a low complexity bit-parallel systolic architecture for computing C+AB, AB, C+AB² or AB² over a class of GF(2^{m}) free global connection.

2. Description of Related Art

Finite fields GF(2^{m}) have broadly applied to error control coding and cryptography [reference 12]. The fundamental operations in a finite field are addition, multiplication, exponentiation, division and multiplicative inversion. However, information processing usually requires the power-sum (C+AB²) operation to be performed in error control coding. AB² circuits have been shown to be more effective than AB circuits in performing exponentiation, inversion and division in GF(2^{m}). This AB² operation can be performed by typical multiplication, but not necessarily in an efficient way. Recently, several studies have sought to solve this problem. For example Wei [reference 1] presented a systolic array with bi-directional data flow to compute C+AB² over GF(2^{m}) using the standard basis representation, Wang and Guo [reference 2] presented a systolic array with unidirectional data flow over GF(2^{m}); Liu [reference 3] proposed an AB² multiplier that used a cellular architecture in GF(2^{m}) and was based on an irreducible all one polynomial (AOP), and Lee [reference 4] presented a bit-parallel systolic array over a class of GF(2^{m}) which also based on an irreducible AOP. This study focuses on the implementation of the systolic circuit of the C+AB, AB, C+AB or AB² operation over the class of AOP-based GF(2^{m}) and the class of equally spaced polynomial based (ESP-based) GF(2^{m}).

Irreducible AOP or irreducible ESP generates a special finite field, in which arithmetic operation can be simplified. In 1989, Itoh and Tsujii [reference 5] designed two low-complexity multipliers in a class of GF(2^{m}) based on the irreducible AOP of degree m or the irreducible ESP of degree mr. Since then, many bit-parallel low-complexity multipliers have been proposed for error-control coding or cryptographic applications, such as those described in [references 6-9]. Recently, Lee et. al. [reference 10] employed cyclic shifting and inner product to implement efficient systolic multipliers over a class of GF(2^{m}), in which an irreducible AOP or an irreducible ESP generates each element of the finite field, such that the systolic circuits have low latency and low complexity. However, the circuit includes many surplus inputs and latches [reference 10] if the order m of GF(2^{m}) is large. Later, Lee et. al. [reference 11] used some global connections disused inputs and latches in another design. In particular, public-key cryptography applies the finite field GF(2^{m}) [reference 12], in which the order m ranges from dozens to hundreds. If m is in the order of hundred, then reducing the number of redundant inputs and latches or eliminating the global connections becomes important.

This study develops an algorithm for computing C+AB, AB, C+AB² or AB² over a class of fields GF(2^{m}) using the characteristics of an irreducible AOP of degree m. Based on the algorithm, a ringed parallel-in parallel-out systolic multiplier for computing C+AB² is proposed. The multiplier consists of m² identical cells, each consisting of one 2-input AND gate, one 2-input XOR gate and three 1-bit latches. The gates in the multiplier are fewer than in [reference 3, 4, 10 or 11]. The architecture includes no redundant inputs, latches and has no global connections; it is therefore is suitable for use in VLSI design. Moreover, extending this algorithm enables the ringed bit-parallel systolic architecture over the class of GF(2^{m}) also to be applied to ESP-based multiplication over the class of GF(2^{nr}).

### SUMMARY OF THE INVENTION

The main objective of the present invention is to provide an improved a bit-parallel systolic architecture for computing C+AB, AB, C+AB² or AB² over a class of GF(2^{m}) based on the irreducible all one polynomial (AOP) or the irreducible equally spaced polynomial (ESP), where A, B and C are elements of GF(2^{m}).

To achieve the objective, If elements over GF(2^{m}) are represented by extended forms, then these elements have two important properties: first, the polynomial of the elements is cyclic with modulo x^{m+1}+1, and second, some fixed zero terms of the product of two elements can be ignored in the polynomials. Then, with these properties, ringed low-complexity bit-parallel systolic multipliers are presented. The ringed bit-parallel systolic multiplier over the class of GF(2^{m}) requires few gates and no global connections. Accordingly, the new multiplier has a low complexity and few input pins. This ringed configuration can be easily implemented by taking advantage of three-dimensional routing in VLSI systems. The architecture of the multiplier was designed to compute C+AB² over GF(2⁴), based on the irreducible AOP, or over GF(2⁶), based on the irreducible ESP as examples, respectively. Notably, the field GF(2⁴) or GF(2⁶) is used to illustrate the structures and operations of the two new multipliers presented in this paper, However, the extension of these structures to a general case of GF(2^{m}) is straightforward.

Further benefits and advantages of the present invention will become apparent after a careful reading of the detailed description with appropriate reference to the accompanying drawings.

### BRIEF DESCRIPTION OF THE DRAWINGS

FIG. 1(a) is a bit-parallel systolic inner product unit for the C+AB, AB, C+AB² or AB² over GF(2⁴) in accordance with the present invention;

FIG. 1(b) is a detailed circuit of U_{i,j} cell;

FIG. 1(c) is a modular unit

FIG. 2 is a cyclic sequence <a⁰ a² a⁴ a¹ a³> with modulo (a⁵+1);

FIG. 3 is a ringed bit-parallel systolic circuit for computing C+AB, AB, C+AB² or AB over GF(2⁴) based on the irreducible AOP of degree 4; and

FIG. 4 is a ringed systolic structure for computing C+AB, AB, C+AB² or AB² over GF(2⁶) based on the irreducible ESP of degree 6.

### DETAILED DESCRIPTION OF THE INVENTION

1. Mathematical Background

These section introduces the properties of the cyclic shifting and the inner product of the field GF(2^{m}) based on an irreducible AOP introduced in [reference 10]. These properties are important in developing the multipliers hereinafter.

1.1 Extended Canonical Basis

A polynomial of the form p(x)=p₀+p₁x+ . . . +pₘx^{m} over GF(2) is called an AOP of degree m if pᵢ=1 for i=0, 1, . . . , m [reference 5]. An AOP has been shown to be irreducible if and only if m+1 is a prime and 2 is a primitive element of the field GF(m+1). For m≦100, the possible values of m for which an AOP of degree m is irreducible, are 2, 4, 10, 12, 18, 28, 36, 52, 58, 60, 66, 82 and 100.

Suppose that a is a root of an irreducible AOP of degree m; then any element A in the Galois field GF(2^{m}) can be represented as A=a₀+a₁a+a₂a²+ . . . +aₘ₋₁a^{m-1}, where the coefficients aᵢεGF(2) for 0≦i≦m−1, and {1, a, a², . . . , a^{m-1}} is called a canonical basis of GF(2^{m}). Notably, the element A can also be represented as A=A₀+A₁a+A₂a²+ . . . +Aₘa^{m}, with Aᵢ=aᵢ+Aₘ for 0≦i≦m−1 and Aₘ=0 or 1. The basis {1, a, a², . . . , a^{m}} is then called an extended basis of the canonical basis {1, a, a², . . . , a^{m-1}}.

1.2 Inner Product

Let P(x)=1+x+x²+ . . . +x^{m} be an irreducible AOP of degree m; and let α be a root of P(x), such that P(α)=1+α+α²+ . . . +α^{m}=0. Then,
α^{m+1}=1, (1)
Definition 1: Let A=A₀+A₁a+A₂a²+ . . . +Aₘa^{m} be an element in GF(2^{m}), which is represented with the extended basis. Then, A⁽¹⁾(=Aₘ+A₀a+A₁a²+ . . . +Aₘ₋₁a^{m}) and A⁽⁻¹⁾(=A₁+A₂a+A₃a²+ . . . +A₀a^{m}) denote the elements obtained by shifting A cyclically one position to the right and one position to the left, respectively.

Analogously, A⁽ⁱ⁾ and A⁽⁻ⁱ⁾, where i=0, 1, 2 . . . m, represent the elements obtained by shifting A cyclically i positions to the right and i positions to the left, respectively.

$$\begin{matrix}{A}^{( i )} = {A}_{m - i + 1} + {A}_{m - i + 2} α + … + {A}_{m - i} {α}^{m} & ( 2 ) \\ = {\sum }_{j = 0}^{m} {A}_{〈 j - i 〉} {α}^{j} & \\ {A}^{( - i )} = {A}_{i} + {A}_{i + 1} α + … + {A}_{〈 m + i 〉} {α}^{m} & ( 3 ) \\ = {\sum }_{j = 0}^{m} {A}_{〈 j + 1 〉} {α}^{j} & \end{matrix}$$

where <θ>, the subscript of A_{<θ>}, represents the least nonnegative residues of θ modulo m+1 (for all AOP-based GF(2^{m})). Notably, A⁽⁰⁾=A⁽⁻⁰⁾=A.

An important operation, called the inner product, is defined as follows.
Definition 2: Let A=A₀+A₁a+ . . . +Aₘa^{m} and B=B₀+B₁a+ . . . +Bₘa^{m} be two elements of GF(2^{m}), where a is a root of the irreducible AOP of degree m. Then the inner product of A and B is defined as,

$$\begin{matrix}A \cdot B = ( {\sum }_{j = 0}^{m} {A}_{j} {α}^{j} ) \cdot ( {\sum }_{j = 0}^{m} {B}_{j} {α}^{j} ) \\ = {\sum }_{j = 0}^{m} {A}_{j} {B}_{j} {α}^{2 j}\end{matrix} \qquad ( 4 )$$

By Definitions 1 and 2, the inner product of A⁽ⁱ⁾ and B⁽ⁱ⁾ is given by,

$$\begin{matrix}{A}^{( i )} \cdot {B}^{( - i )} = ( {\sum }_{j = 0}^{m} {A}_{〈 j - i 〉} {α}^{j} ) \cdot ( {\sum }_{j = 0}^{m} {B}_{〈 j + i 〉} {α}^{j} ) \\ = {\sum }_{j = 0}^{m} {A}_{〈 j - i 〉} {B}_{〈 j + i 〉} {α}^{2 j}\end{matrix} \qquad ( 5 )$$

The inner product operation defined in Definition 2 is important in the proposed algorithm.
Theorem 1: Assume that A=A₀+A₁a+ . . . +Aₘa^{m} and B=B₀+B₁a+ . . . . +Bₘa^{m} are two elements in GF(2^{m}). Then, the A and B over GF(2^{m}) can be multiplied using,

$$\begin{matrix}AB = {A}^{( 0 )} \cdot {B}^{( - 0 )} + {A}^{( 1 )} \cdot {B}^{( - 1 )} + … + {A}^{( m )} \cdot {B}^{( - m )} \\ = {\sum }_{i = 0}^{m} {A}^{( i )} \cdot {B}^{( - i )}\end{matrix} \qquad ( 6 )$$

Based on theorem 1, bit-parallel systolic multipliers for computing C+AB² was presented in [reference 3] and [reference 4] the latency of those multipliers is only m+1 clock cycles. However, the circuit still requires (m+1)² cells and 5m+3 input pins. Following the above preliminaries, Section 3 presents a modified multiplier for computing C+AB over GF(2^{m}), based on an irreducible AOP.

2. Multiplier for Computing C+AB²

2.1 Representation for Computing C+AB²

Definition 3: Let B=B₀+B₁a+ . . . +Bₘa^{m} be over GF(2^{m}) be generated by an irreducible AOP of p(x), where a is a root of the irreducible AOP of p(x). Then the square of B is defined as,

$$\begin{matrix}{B}^{2} = {( {B}_{0} + {B}_{1} a + {B}_{2} {a}^{2} + … + {B}_{m} {a}^{m} )}^{2} \\ = {B}_{0} + {B}_{1} {a}^{2} + {B}_{2} {a}^{4} + … + {B}_{m} {a}^{2 m} \\ = {S}_{0} + {S}_{1} a + {S}_{2} {a}^{2} + … + {S}_{m} {a}^{m}\end{matrix} \qquad ( 7 )$$

$$where , {S}_{i} = \{ \begin{matrix}{B}_{i / 2} , & even i \\ {B}_{( i + m + 1 ) / 2} , & odd i\end{matrix} \qquad ( 8 )$$

Let A and B be two elements of GF(2^{m}), both represented with the extended basis {1, a, a², . . . , a^{m}}; then, the inner product of A and B² is obtained by,

$$\begin{matrix}A \cdot {B}^{2} = ( {A}_{0} ) ( {S}_{0} ) + ( {A}_{1} {α}^{1} ) ( {S}_{1} {α}^{1} ) + … + ( {A}_{m} {α}^{m} ) ( {S}_{m} {α}^{m} ) \\ = ( {\sum }_{j = 0}^{m} {A}_{j} {α}^{j} ) \cdot ( {\sum }_{j = 0}^{m} {S}_{j} {α}^{j} ) \\ = {\sum }_{j = 0}^{m} {A}_{j} {S}_{j} {α}^{2 j}\end{matrix} \qquad ( 9 )$$

By Definitions 1 and 2 again, the inner product of A⁽ⁱ⁾ and (B²)⁽⁻ⁱ⁾ is given by,

$$\begin{matrix}{A}^{( i )} \cdot {( {B}^{2} )}^{( - i )} = ( {\sum }_{j = 0}^{m} {A}_{〈 j - i 〉} {α}^{j} ) \cdot ( {\sum }_{j = 0}^{m} {S}_{〈 j + i 〉} {α}^{j} ) \\ = {\sum }_{j = 0}^{m} {A}_{〈 j - i 〉} {S}_{〈 j + i 〉} {α}^{2 j}\end{matrix} \qquad ( 10 )$$

According to Eqs. (1) and (7), the product of A and B² over GF(2^{m}) is,

$$\begin{matrix}{AB}^{2} = ( {A}_{0} + {A}_{1 a} + {A}_{2} {a}^{2} + … + {A}_{m} {a}^{m} ) ( {S}_{0} + {S}_{1} a + \\ {S}_{2} {a}^{2} + … + {S}_{m} {a}^{m} ) \\ = ( {\sum }_{j = 0}^{m} {A}_{j} {α}^{j} ) ( {\sum }_{i = 0}^{m} {S}_{i} {α}^{i} ) \\ = {\sum }_{i = 0}^{m} {\sum }_{j = 0}^{m} {A}_{j} {S}_{〈 i - j 〉} {α}^{i}\end{matrix} \qquad ( 11 )$$

$$where , {S}_{〈 i - j 〉} = \{ \begin{matrix}{B}_{〈 ( i - j ) / 2 〉} , & even ( i - j ) \\ {B}_{〈 ( i - j + m + 1 ) / 2 〉} , & odd ( i - j )\end{matrix}$$

### EXAMPLE 1

Assume that A=A₀+A₁a+A₂a²+A₃a³+A₄a⁴ and B=B₀+B₁a+B₂a²+B₃a³+B₄a⁴ are two elements in the field GF(2⁴). Let D=D₀+D₁a+D₂a²+D₃a³+D₄a⁴ denote the product of A and B² over GF(2⁴).

$$\begin{matrix}D = {AB}^{2} = ( {A}_{0} + {A}_{1} a + {A}_{2} {a}^{2} + {A}_{3} {a}^{3} + {A}_{4} {a}^{4} ) \\ ( {S}_{0} + {S}_{1} a + {S}_{2} {a}^{2} + {S}_{3} {a}^{3} + {S}_{4} {a}^{4} ) \\ = ( {A}_{0} + {A}_{1} a + {A}_{2} {a}^{2} + {A}_{3} {a}^{3} + {A}_{4} {a}^{4} ) \\ ( {B}_{0} + {B}_{3} a + {B}_{1} {a}^{2} + {B}_{4} {a}^{3} + {B}_{2} {a}^{4} )\end{matrix}$$

Then, from Eq. (1), a⁵=1, and from Eq. (11), the coefficients of D are given by,
D₀=A₀B₀+A₄B₃+A₃B₁+A₂B₄+A₁B₂,
D₁=A₁B₀+A₀B₃+A₄B₁+A₃B₄+A₂B₂,
D₂=A₂B₀+A₁B₃+A₀B₁+A₄B₄+A₃B₂,
D₃=A₃B₀+A₂B₃+A₁B₁+A₀B₄+A₄B₂,
and
D₄=A₄B₀+A₃B₃+A₂B₁+A₁B₄+A₀B₂.
2.2 AOP-Based Algorithm and Circuit
Theorem 2: Assume that A=A₀+A₁a+A₂a²+ . . . +Aₘa^{m} and B=B₀+B₁a+B₂a²+ . . . +Bₘa^{m} are two elements in GF(2^{m}). Then, A and B² over GF(2^{m}) can be multiplied using,

$$\begin{matrix}{AB}^{2} = {A}^{( 0 )} \cdot {( {B}^{2} )}^{( - 0 )} + {A}^{( 1 )} \cdot {( {B}^{2} )}^{( - 1 )} + … + {A}^{( m )} \cdot {( {B}^{2} )}^{( - m )} \\ = {\sum }_{i = 0}^{m} {A}^{( i )} \cdot {( {B}^{2} )}^{( - i )}\end{matrix}$$

Proof: A and B are two elements in GF(2^{m}); then, the product A and B² can be obtained from Eq. (11) as,

$${AB}^{2} = {\sum }_{i = 0}^{m} {\sum }_{j = 0}^{m} {A}_{j} {S}_{< i - j >} {α}^{i} .$$

Splitting the right side of this equation into two terms with i=even and i=odd, yields,

$${AB}^{2} = {{\sum }_{i = 0}^{m}}_{even} {\sum }_{j = 0}^{m} {A}_{< i - j >} {S}_{j} {α}^{i} + {{\sum }_{i = 1}^{m - 1}}_{odd} {\sum }_{j = 0}^{m} {A}_{< i - j >} {S}_{j} {α}^{i} . \qquad ( 12 )$$

Notably, m must be even for an irreducible AOP of degree m. Substituting aⁱ=a^{m+1+i} and <i−j>=<m+1+i−j> into the second term on the right side of Eq. (12) gives

$${AB}^{2} = {{\sum }_{i = 0}^{m}}_{even} {\sum }_{j = 0}^{m} {A}_{< i - j >} {S}_{j} {α}^{i} + {{\sum }_{i = 0}^{m}}_{odd} {\sum }_{j = 0}^{m} {A}_{< m + 1 + i - j >} {S}_{j} {α}^{m + 1 + i} . \qquad ( 13 )$$

Taking i=2p for i=even where p=0, 1, . . . , m/2, and taking i=2p−m−1 for i=odd, where p=(m/2)+1, (m/2)+2, . . . , m, Eq. (13) can be rewritten as,

$${AB}^{2} = {\sum }_{p = 0}^{m} {\sum }_{j = 0}^{m} {A}_{< 2 p - j >} {S}_{j} {α}^{2 p} . \qquad ( 14 )$$

Let k be an integer such that 0≦k≦m. Then <p+k> must be in the range 0≦<p+k>≦m for 0≦p≦m. Thus, j=<p+k> can be substituted into the subscripts of A_{<2p-j>}Sⱼ in Eq. (14) to obtain,

$${AB}^{2} = {\sum }_{k = 0}^{m} {\sum }_{p = 0}^{m} {A}_{< p - k >} {S}_{< p + k >} {α}^{2 p} . \qquad ( 15 )$$

Comparing Eq. (15) with Eq. (10) finally gives,

$${AB}^{2} = {\sum }_{k = 0}^{m} {A}^{( k )} \cdot {S}^{( - k )}$$

That is,

$${AB}^{2} = {\sum }_{i = 0}^{m} {A}^{( i )} \cdot {( {B}^{2} )}^{( - i )}$$

### EXAMPLE 2

Assume that {1, a, a², a³, a⁴} is an extended basis of the field GF(2⁴). Let A=A₀+A₁a+A₂a²+A₃a³+A₄a⁴ and B=B₀+B₁a+B₂a²+B₃a³+B₄a⁴ be two elements of the field GF(2⁴). And let D=D₀+D₁a+D₂a²+D₃a³+D₄a⁴ be the product of A and B². By employing the properties of a^{m+1+i}=aⁱ modulo (a^{m+1}+1) for m=4, the product D can then be computed using Theorem 2:

$$\begin{matrix} & {a}^{0} & {a}^{2} & {a}^{4} & {a}^{6} ( = {a}^{1} ) & {a}^{8} ( = {a}^{3} ) \\ {A}^{( 0 )} \cdot {( {B}^{2} )}^{( - 0 )} = & {A}_{0} {B}_{0} & {A}_{1} {B}_{3} & {A}_{2} {B}_{1} & {A}_{3} {B}_{4} & {A}_{4} {B}_{2} \\ {A}^{( 1 )} \cdot {( {B}^{2} )}^{( - 1 )} = & {A}_{4} {B}_{3} & {A}_{0} {B}_{1} & {A}_{1} {B}_{4} & {A}_{2} {B}_{2} & {A}_{3} {B}_{0} \\ {A}^{( 2 )} \cdot {( {B}^{2} )}^{( - 2 )} = & {A}_{3} {B}_{1} & {A}_{4} {B}_{4} & {A}_{0} {B}_{2} & {A}_{1} {B}_{0} & {A}_{2} {B}_{3} \\ {A}^{( 3 )} \cdot {( {B}^{2} )}^{( - 3 )} = & {A}_{2} {B}_{4} & {A}_{3} {B}_{2} & {A}_{4} {B}_{0} & {A}_{0} {B}_{3} & {A}_{1} {B}_{1} \\ + {A}^{( 4 )} \cdot {( {B}^{2} )}^{( - 4 )} = & {A}_{1} {B}_{2} & {A}_{2} {B}_{0} & {A}_{3} {B}_{3} & {A}_{4} {B}_{1} & {A}_{0} {B}_{4} \\ & {D}_{0} & {D}_{2} & {D}_{4} & {D}_{1} & {D}_{3}\end{matrix}$$

Definition 4: Let A=A₀+A₁a+ . . . +Aₘa^{m} and B=B₀+B₁a+ . . . +Bₘa^{m} be two elements of GF(2^{m}), represented with the extended basis {1, a, a², . . . , a^{m}}, where a is a root of the irreducible AOP of degree m. If A and B are represented with Aₘ=Bₘ=0, then AᵢBₘ and AₘBᵢ equal zero, for 0≦i≦m. Those terms are called fixed zero terms.

Definition 4 yields the following theorem.

Theorem 3: Assume that A=A₀+A₁a+ . . . +Aₘa^{m} and B=B₀+B₁a+ . . . +Bₘa^{m} are two elements in GF(2^{m}), and a is a root of the irreducible. AOP of degree m. If A and B are represented with Aₘ=Bₘ=0, then the product of A and B over GF(2^{m}) includes 2m+1 fixed zero terms.
Proof: According to Eq. (11), the product of A and B² over GF(2^{m}) has (m+1)² terms Since Aₘ=Bₘ=0, Eq. (11) can be simplified as,

$${AB}^{2} = ( {A}_{0} + {A}_{1} α + … + {A}_{m - 1} {α}^{m - 1} + 0 {α}^{m} ) {( {B}_{0} + {B}_{1} α + … + {B}_{m - 1} {α}^{m - 1} + 0 {α}^{m} )}^{2} = ( {A}_{0} + {A}_{1} α + … + {A}_{m - 1} {α}^{m - 1} ) ( {B}_{0} + {B}_{1} {α}^{2} + … + {B}_{m - 1} {α}^{2 ( m - 1 )} ) = ( {\sum }_{j = 0}^{m - 1} {A}_{j} {α}^{j} ) ( {\sum }_{i = 0}^{m - 1} {B}_{i} {α}^{< 2 i >} ) \qquad ( 16 )$$

According to Eq. (16) the product of A and B² over GF(2^{m}) has m×m=m² terms. Therefore, the product of A and B² over GF(2^{m}) has 2 m+1 fixed zero terms.

Using theorem 3, the C+AB² circuit can be simplified by omitting the fixed zero terms. The following example illustrates the fixed zero terms of C+AB² over GF(2⁴).

### EXAMPLE 3

Assume that {1, a, a², a³, a⁴} is an extended basis of the field GF(2⁴). Let A=A₀+A₁a+A₂a²+A₃a³+A₄a⁴, B=B₀+B₁a+B₂a²+B₃a³+B₄a⁴ and C=C₀+C₁a+C₂a²+C₃a³+C₄a⁴ be three elements of the field GF(2⁴), where A₄=B₄=C₄=0. Let D=D₀+D₁a+D₂a²+D₃a³+D₄a⁴ be the product of C+AB 2. The product D can then be computed using theorems 1 and 3:

$$\begin{matrix} & {a}^{0} & {a}^{2} & {a}^{4} & {a}^{6} ( = {a}^{1} ) & {a}^{8} ( = {a}^{3} ) \\ C = & {C}_{0} & {C}_{2} & {C}_{4} & {C}_{1} & {C}_{3} \\ {A}^{( 0 )} \cdot {( {B}^{2} )}^{( - 0 )} = & {A}_{0} {B}_{0} & {A}_{1} {B}_{3} & {A}_{2} {B}_{1} & ( {A}_{3} {B}_{4} = 0 ) & ( {A}_{4} {B}_{2} = 0 ) \\ {A}^{( 1 )} \cdot {( {B}^{2} )}^{( - 1 )} = & ( {A}_{4} {B}_{3} = 0 ) & {A}_{0} {B}_{1} & ( {A}_{1} {B}_{4} = 0 ) & {A}_{2} {B}_{2} & {A}_{3} {B}_{0} \\ {A}^{( 2 )} \cdot {( {B}^{2} )}^{( - 2 )} = & {A}_{3} {B}_{1} & ( {A}_{4} {B}_{4} = 0 ) & {A}_{0} {B}_{2} & {A}_{1} {B}_{0} & {A}_{2} {B}_{3} \\ {A}^{( 3 )} \cdot {( {B}^{2} )}^{( - 3 )} = & ( {A}_{2} {B}_{4} = 0 ) & {A}_{3} {B}_{2} & ( {A}_{4} {B}_{0} = 0 ) & {A}_{0} {B}_{3} & {A}_{1} {B}_{1} \\ + {A}^{( 4 )} \cdot {( {B}^{2} )}^{( - 4 )} = & {A}_{1} {B}_{2} & {A}_{2} {B}_{0} & {A}_{3} {B}_{3} & ( {A}_{4} {B}_{1} = 0 ) & ( {A}_{0} {B}_{4} = 0 ) \\ D = & {D}_{0} & {D}_{2} & {D}_{4} & {D}_{1} & {D}_{3}\end{matrix}$$

Example 3 involves nine fixed zero terms that forms A4Bi and AiB4 are zeroes and need not be computed.

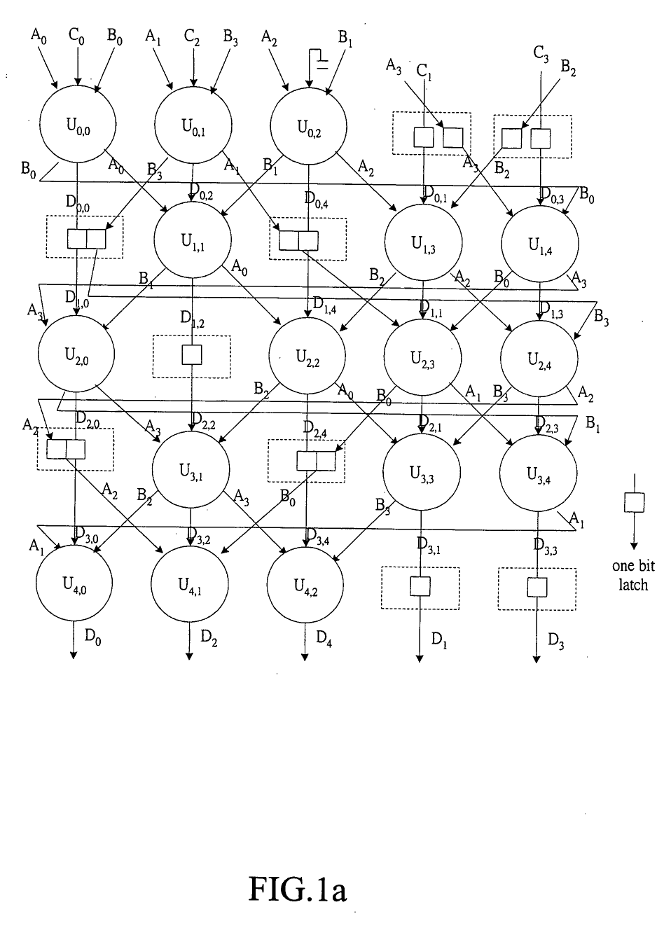

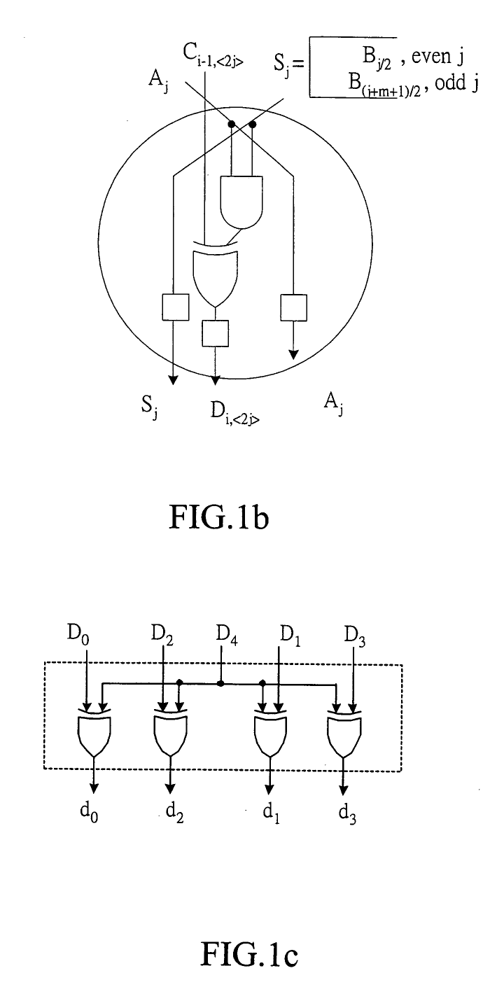

FIG. 1(a) shows a parallel-in-parallel-out systolic multiplier to perform the above computation. The multiplier consists of 16 U cells and nine latch units. Each U cell employs one 2-input AND gate and one 2-input XOR gate, as shown in FIG. 1(b). The three 1-bit latches in each cell are used to delay each output of the cell by one clock cycle. Notably, bits A₄, B₄ and C₄ are zeroes and need not be input. The modular unit (MU), as shown in FIG. 1(c), is used to compute the operation of modulo p(α). Since p(α)=1+α+α²+α³+α⁴=0 (or α⁴=1+α+α²+α³), the product can be obtained from the relationship D(a)=d₀+d₁a+d₂a²+d₃a³=D₀+D₁a+D₂a²+D₃a³+D₄a⁴ mod p(α); and therefore dᵢ=Dᵢ+D₄, for i=0, 1, 2, 3.

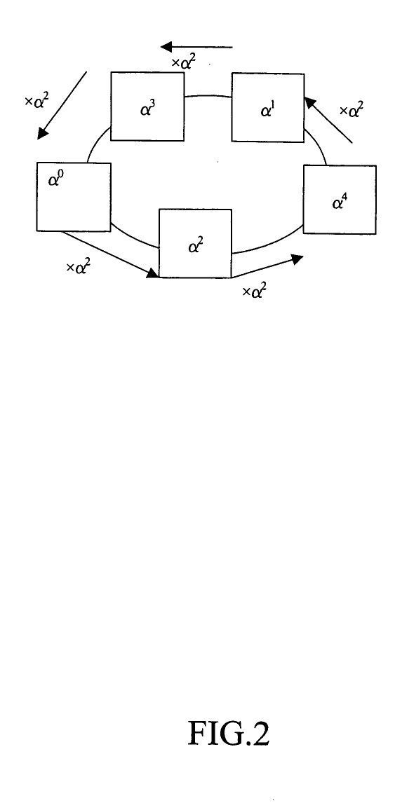

2.3 Ringed AOP-Based circuit FIG. 1(a) shows some global connections that cause a long delay in a VLSI circuit over GF(2^{m}) if m is large. From Eq. (5), the order of a²ⁱ has a cyclic property with modulo (a^{m+1}+1). For example, the sequence <a⁰ a² a⁴ a¹ a³> is cyclic with modulo (a⁵+1) as in FIG. 2.

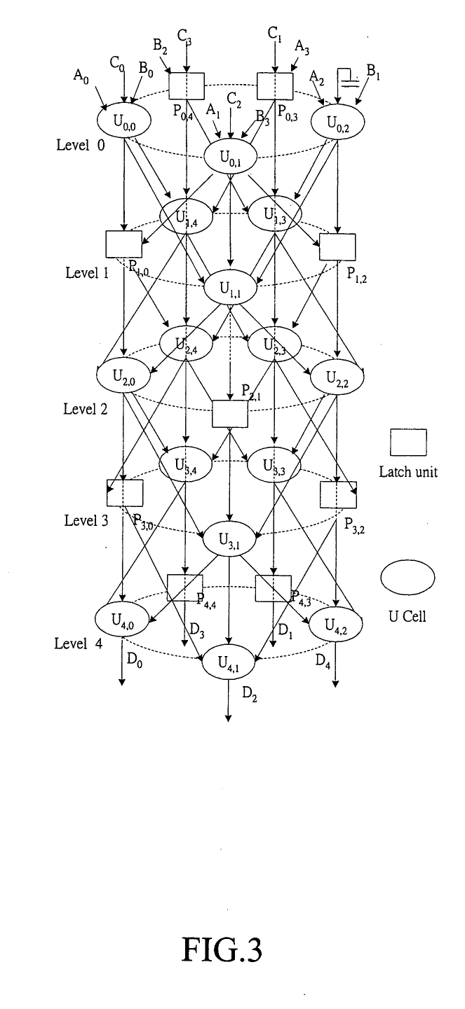

Using the cyclic property of the sequence <a⁰ a² a⁴ a¹ a³>, FIG. 3 depicts a ringed parallel-in parallel-out systolic multiplicative circuit that realizes the computation in example 3. The circuit includes 16 U cells, U_{i,j}, where i and j are the row and column numbers, respectively. The circuit of the U cell is that same as that shown in FIG. 1. FIG. 3 performs the following equations.
T_{0,j}=C_{<2j>}, initialization, for j=0, 1 . . . , m. (17)
T_{i+1,j}=T_{i,j}+Aⱼ⁽ⁱ⁾Sⱼ⁽⁻ⁱ⁾, for i=0, 1 . . . , m and j=0, 1 . . . , m (18)
D_{<2j>}=T_{m+1,j}, for j=0, 1 . . . , m (19)

Where Sⱼ is defined as in Eq. (8). The product D can be computed, as the following steps:

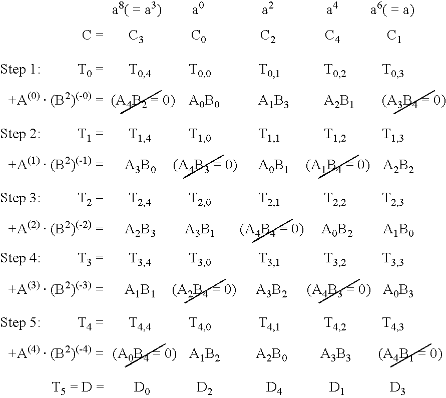

The item a³ is rearranged to the leftest by cyclic property in above steps. The advantage of the circuit in FIG. 3 is no any global connections. Several points should be addressed. Using Eq. (18), in the ring level 0, the U cell at position P_{0,3} for computing the bit operation T_{1,3}=T_{0,3}+A₃B₄ can be replaced by a bit latch because B₄=0, and the U cell at position P_{0,4} for computing the bit operation T_{1,4}=T_{0,4}+A₄B₂ can be replaced by a bit latch because A₄=0. In the next level ring, A₄ or B₄ shifts to the right or the left, respectively. Then, in the ring level 1, at position P_{1,0} or P_{1,2} each bit operation for computing T_{2,0}=T_{1,0}+A₄B₃ or T_{2,2}=T_{1,2}+A₁B₄ requires only one bit latch rather than a U cell. The others, the positions P_{2,1} P_{3,0} P_{3,2} P_{4,3}, and P_{4,4}, can be replaced by bit latches.

The positions of the ring using latches instead of U-cells are as the follows.

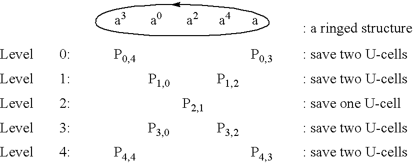

Where P_{i,j} denotes position in row i and column j. In FIG. 3, as in the example illustrated in FIG. 1, the three elements A, B and C in GF(2⁴) are used as the three inputs of the modified version, and D represents the result of C+AB². Comparing the modified circuit with the circuit in [reference 4] shows that the total number of input pins has been reduced from 23 to 12, and the number of U cells has been reduced from 25 to 16.

3. Modified ESP-Based Multiplier

This section proposes an ESP-Based multiplier. The method for computing C+AB² based on an irreducible AOP can also be applied to compute the multiplication based on an irreducible ESP.

3.1 Algorithm

A polynomial of the form g(x)=1+x^{r}+ . . . +x^{(n-1)r}+x^{nr} is called an r-equally spaced polynomial (r-ESP) of degree nr. Let g(x)=p(x^{r}), then p(x) is an AOP of degree n. If p(x) is an irreducible AOP, then r-ESP g(x) has been shown to be irreducible if and only if r=(n+1)^{j}≠1 modulo (n+1)r, for j≧1 [reference 5]. For nr≦100, the possible pairs (nr,r) for which an r-ESP of degree nr is irreducible, are (6,3), (18,9), (20,5), (54,27) and (100,25).

Now, suppose that a is a root of the irreducible r-ESP of degree nr. Then, an element A in the Galois field GF(2^{nr}) can be represented as A=a₀+a₁a+ . . . +aₙᵣ₋₁a^{nr-1} using the canonical basis {1, a, a² . . . , a^{nr-1}} where aᵢεGF(2) for 0≦i≦nr−1. The element A can also be represented using the extended basis {1, a, a², . . . , a^{(n+1)r-1}}, as,

$$A = {A}_{0} + {A}_{1} a + … + {A}_{( n + 1 ) r - 1} {a}^{( n + 1 ) r - 1} = {\sum }_{i = 0}^{( n + 1 ) r - 1} {A}_{i} {α}^{i} ,$$

where Aᵢ=aᵢ, for 0≦i≦nr−1 and Aᵢ=0 for nr≦i≦(n+1)r−1.

### EXAMPLE 4

Assume that a is a root of the r-ESP g(x)=1+x³+x⁶ (that is, g(x) is an irreducible ESP with nr=6 and r=3). Then, {1, a, a², a³, a⁴, a⁵} is a canonical basis of the Galois field GF(2⁶) and {1, a, a², a³, a⁴, a⁵, a⁶, a⁷, a⁸} can be used as an extended basis of this canonical basis. Thus, an element in GF(2⁶) can be represented as A=a₀+a₁a+a₂a²+a₃a³+a₄a⁴+a₅a⁵=A₀+A₁a+A₂a²+A₃a³+A₄a⁴+A₅a⁵+A₆a⁶+A₇a⁷+A₈a⁸ using the extended basis, where the A=aᵢ, for 0≦i≦5, and A₆=A₇=A₈=0.

Theorem 4: Assume that A=A₀+A₁a+ . . . +A₍ₙ₊₁₎ᵣ₋₁a^{(n+1)r-1} and B=B₀+B₁a+ . . . +B₍ₙ₊₁₎ᵣ₋₁a^{(n+1)r-1} are two elements in GF(2^{nr}), which are represented with the extended basis {1, a, a², . . . , a^{(n+1)r-1}} where a is a root of the irreducible r-ESP of degree nr. Then, the product of A and B² over GF(2^{nr}) includes (2n+1)r² fixed zero terms of the form AᵢBⱼ or AⱼBᵢ, for nr≦j≦(n+1)r−1, and 0≦i≦(n+1)r−1, if A and B are represented with Aⱼ=Bⱼ=0, for nr≦j≦(n+1)r−1.
Proof: According to Eq. (16), the product of A and B² over GF(2^{nr}) is,

$${AB}^{2} = ( {A}_{0} + {A}_{1} α + … + {A}_{( n + 1 ) r - 1} {α}^{( n + 1 ) r - 1} ) {( {B}_{0} + {B}_{1} α + … + {B}_{( n + 1 ) r - 1} {α}^{( n + 1 ) r - 1} )}^{2} , = ( {\sum }_{j = 0}^{( n + 1 ) r - 1} {A}_{j} {α}^{j} ) ( {\sum }_{i = 0}^{( n + 1 ) r - 1} {B}_{i} {α}^{< 2 i >} ) , = {\sum }_{i = 0}^{( n + 1 ) r - 1} {\sum }_{j = 0}^{( n + 1 ) r - 1} {A}_{j} {B}_{< i - j >} {α}^{i} . \qquad ( 20 )$$

where <θ>, the subscript of B_{<θ>}, denotes the least nonnegative residues of θ modulo (n+1)r (for all ESP-Based GF(2^{nr})). Equation (20) has ((n+1)r)² multiplicative terms. Since Aⱼ=Bⱼ=0 for nr≦j=(n+1)r−1, Eq. (20) can be simplified as,

$${AB}^{2} = ( {A}_{0} + {A}_{1} α + … + {A}_{nr - 1} {α}^{nr - 1} ) {( {B}_{0} + {B}_{1} α + … + {B}_{nr - 1} {α}^{nr - 1} )}^{2} , = ( {\sum }_{j = 0}^{nr - 1} {A}_{j} {α}^{j} ) ( {\sum }_{i = 0}^{nr - 1} {B}_{i} {α}^{< 2 i >} ) , = {\sum }_{i = 0}^{nr - 1} {\sum }_{j = 0}^{nr - 1} {A}_{j} {B}_{< i - j >} {α}^{i} . \qquad ( 21 )$$

According to Eq. (21) the product of A and B² over GF(2^{nr}) has (nr)² terms. Therefore, the product of A and B² over GF(2^{m}) has ((n+1)r)²−(nr)²=(2n+1)r² fixed zero terms.

Since a is a root of the irreducible r-ESP g(x)=1+x^{r}+ . . . +x^{nr}, g(a)=1+a^{r}+ . . . +a^{nr}=0. Assume that two elements A=A₀+A₁a+A₂a²+ . . . +A₍ₙ₊₁₎ᵣ₋₁a^{(n+1)r-1} and B=B₀+B₁a+B₂a²+ . . . +B₍ₙ₊₁₎ᵣ₋₁a^{(n+1)r-1}; then, the product of A and B², according to Theorem 2 and Eq. (20), can be expressed as,

$${AB}^{2} = {A}^{( 0 )} \cdot {( {B}^{2} )}^{( - 0 )} + {A}^{( 1 )} \cdot {( {B}^{2} )}^{( - 1 )} + … + {A}^{( ( n + 1 ) r - 1 )} \cdot {( {B}^{2} )}^{( - ( n + 1 ) r + 1 )} = {\sum }_{i = 0}^{( n + 1 ) r - 1} {A}^{( i )} \cdot {( {B}^{2} )}^{( - i )} \qquad ( 22 )$$

Thus, the method of multiplication based on an irreducible AOP can also be used for multiplication based on an irreducible ESP.
3.2 Ringed Circuit of an ESP-Based Multiplier

Assume that two elements A=a₀+a₁a+a₂a²+a₃a³+a₄a⁴+a₅a⁵=A₀+A₁a+A₂a²+ . . . +A₈a⁸ and B=b₀+b₁a+b₂a+b₃a+b₄a⁴+b₅a⁵=B₀+B₁α+B₂α²+ . . . +B₈α⁸, Let D=D₀+D₁a+D₂a²+ . . . +D₈a⁸ be the product of AB²+C, where A, B and C are elements over GF(2⁶). Set the initial value T₀=C. The product D can then be computed using Eq. (22), as follows.

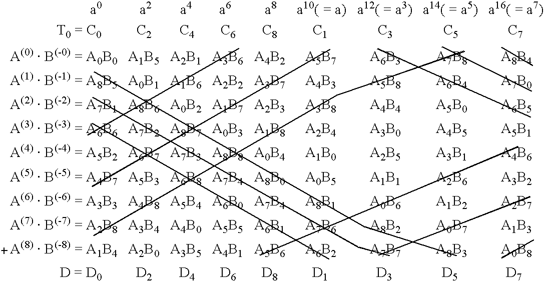

The sequence D₀, D₂, D₄, D₆, D₈, D₁, D₃, D₅, D₇, is a permutation of the sequence D₀, D₁, D₂, D₃, D₄ D₅, D₆, D₇, D₈. Notably, the terms that include A₆, A₇, A₈, B₆, B₇ and B₈ are all zeros, such that AⱼBₖ and AₖBⱼ need not be computed for 6≦j≦8 and 0≦k≦8. Using Eq. (18), the zeroth ring level, U cells for computing the bit operation T_{1,3}=T_{0,3}+A₃B₆, T_{1,5}=T_{0,5}+A₅B₇ and T_{1,7}=T_{0,7}+A₇B₈ can be replaced by bit latches respectively, because B₆=B₇=B₈=0, and those for performing the bit operation T_{1,6}=T_{0,6}+A₆B₃ T_{1,7}=T_{0,7}+A₇B₈, and T_{1,8}=T_{0,8}+A₈B₄ can be replaced by bit latches since A₆=A₇=A₈=0. In the first level ring, A₄ or B₄ shifts to the right or the left, respectively. Then, each bit operation for computing T_{2,2}=T_{1,2}+A₁B₆, T_{2,4}=T_{1,4}+A₃B₇, T_{2,6}=T_{1,6}+A₅B₈, T_{2,7}=T_{1,7}+A₆B₄, T_{2,8}=T_{1,8}+A₇B₀ and T_{2,<9>}=T_{2,0}=T_{1,0}+A₈B₅ requires only one bit latch instead of a U cell, respectively.

Now, positions of the ring that uses latches rather than cells is described briefly as follows.

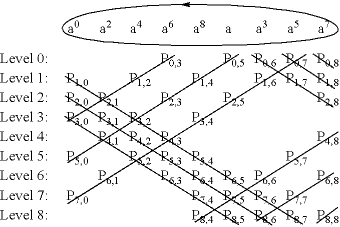

where position P_{i,j}, in which i and j are the row and column numbers, respectively.

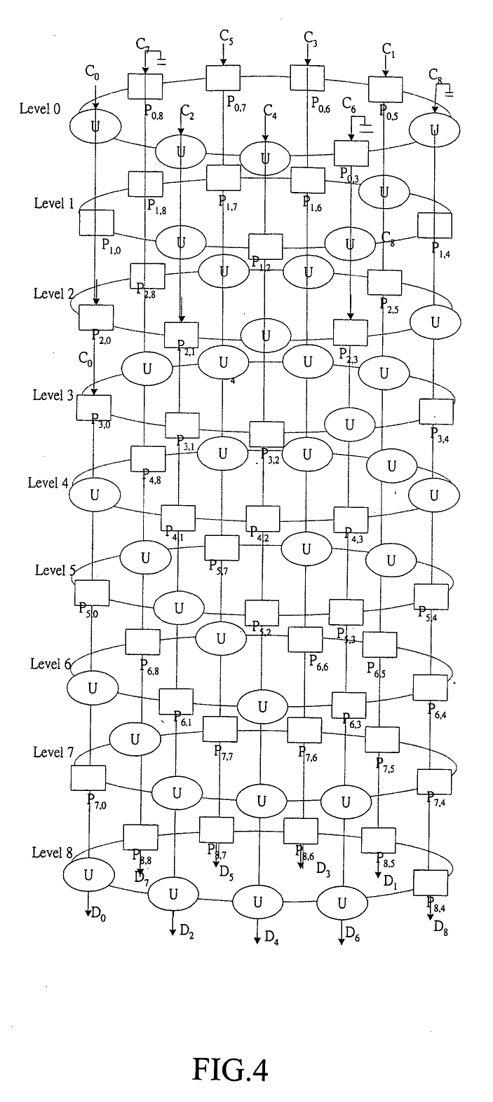

As introduced in Section 3, use a ringed structure to realize the circuit of the cyclic shift sequence <a⁰ a² a⁴ a⁶ a⁸ a¹ a³ a⁵ a⁷>. FIG. 4 depicts the ringed bit-parallel systolic multiplier based on 3-ESP x⁶+x³+1, as a simple illustration; the detail of the U-cell circuit is as shown in FIG. 1. FIG. 4 shows the positions of each level ring that uses a latch rather than a U cell. the proposed ESP-based systolic multiplier comprises (nr)² U cells and (2n+1)r² latch units. Herein, only the positions of the ring in which cells can be replaced by latches are discussed. From FIG. 4, cells over GF(2⁶) in positions P_{i<2j>} with AₖB₆AₖB₇, AₖB₈ and A₆Bₖ A₇Bₖ A₈Bₖ for 0≦k≦8 can be replaced by latches.

The positions of the ringed ESP-based over GF(2^{nr}) are obtained according to a general rule as follows.
Step 1: //Initialization. Hereafter, P_{i,j} denotes the position of level i and column j, in an r-ESP structure
   for every i=1, 2, . . . , (n+1)r−1, and j=1, 2, . . . , (n+1)r−1 that P_{i,j}=U-Cell;
Step 2: //Replace U-cells of AⱼBₖ and AₖBⱼ with latches
   for every i=1, 2, . . . , (n−1)r−1,
      for j=nr+i, nr+i+1, . . . , (n+1)r+i−1 that
         P_{i,j}=Latch; // for AⱼBₖ, where 0≦k≦(n+1)r−1, fixed zero terms,
      for j=(n−1)r−i, (n−1)r−i+2, . . . (n+1)r−i−2, that
      P_{i,j}=Latch; // for AₖBⱼ, where 0≦k≦(n+1)r−1, fixed zero terms
         This rule is suitable for both AOP-based and ESP-based systolic architectures. For r=1, the above algorithm is an AOP-based systolic architecture.

Clearly, the proposed three-dimensional ESP-based systolic architecture over GF(2^{nr}) requires only (n+1)r clock cycles. Moreover, the circuit needs no global connections and the proposed ESP-based systolic multiplier can save (2n+1)r² U cells by ignoring the fixed zero terms.

4. Comparison and Discussion

This work has presented a three-dimensional ringed parallel systolic AOP-based multiplier for computing C+AB, AB, C+AB² or AB² over GF(2^{m}). The latency of the AOP-based multipliers is only m+1 clock cycles in performing a multiplication over GF(2^{m}). The number of input pins is only 3m, which equals the sum of the number of bits in A, B and C. Table 1 compares the new AOP-based parallel systolic multipliers with those of Liu [reference 3], Lee [reference 4] and Lee [reference 11]. The table reveals that the ringed AOP-based multipliers (RAOPM) include fewer gates and fewer input pins than other multipliers. Clearly, the ringed systolic multipliers involve much low hardware complexity and no global connections, which characteristics are of course advantageous in VLSI implementation. Notably, the Architecture of C+AB² is used to illustrate the structures and operations of a new multiplier presented in this paper, However, the extension of these structures to a general case of C+AB, AB or AB² is straightforward.

Although the invention has been explained in relation to its preferred embodiment, it is to be understood that many other possible modifications and variations can be made without departing from the spirit and scope of the invention as hereinafter claimed.

TABLE 1
Comparison of the ringed AOP multiplier with related
bit-parallel systolic multipliers over GF(2^{m}).

| | Multipliers | | | |
|---|---|---|---|---|
| | | | | Proposed |
| Items | Liu[3] | Lee[4] | Lee[11] | in FIG. 3 |
| type | C + AB² | C + AB² | C + AB | C + AB² |
| Number of | | | | |
| total gates | | | | |
| 2-input AND | (m + 1)² | (m + 1)² | (m + 1)² | m² |
| 2-input XOR | (m + 1)² | (m + 1)² | (m + 1)² | m² |
| 1-bit latch | 3(m + 1)² | 3(m + 1)² | 3(m + 1)² | 3m² + |
| | | | | 4m − 1 |
| Minimum possible | T_{A} + | T_{A} + | T_{A} + | T_{A} + |
| clock period | T_{X} + T_{L} | T_{X} + T_{L} | T_{X} + T_{L} | T_{X} + T_{L} |
| Global | Free, but | Free | yes | Free |
| connections | jump | | | |
| | connections | | | |
| Input pins | 5m + 3 | 5m + 3 | 3m + 3 | 3m |
| Latency | 2m + 2 | m + 1 | m + 1 | m + 1 |

### REFERENCES

[1] S. W. Wei, “A Systolic Power-Sum Circuit for GF(2^{m}),” IEEE Trans. on Computers vol. 43, no. 2, pp. 226-229, February 1994.
[2] C. L. Wang and J. H. Guo, “New Systolic Array for C+AB², Inversion, and Division in GF(2^{m}),” IEEE Trans. on Computers vol. 49, no. 10, pp. 1120-1125, October 2000.
[3] C. H. Liu, N. F. Huang and C. Y Lee, “Computation of AB² Multiplier in GF(2^{m}) Using an Efficient Low-Complexity Cellular Architecture,” IEICE Trans. Fundaments, vol. E83-A, no. 12, pp. 2657-2663, December 2000.
[4] C. Y. Lee, E. H. Lu and L. F. Sun, “Low-Complexity Bit-parallel Systolic Architecture for Computing AB²+C in a Class of Finite Field GF(2^{m}),” IEEE Trans. on Circuits Syst. II vol. 48, no. 5, pp. 519-523, May. 2001.
[5] T. Itoh and S. Tsujii, “Structure of parallel multipliers for a class of fields GF(2^{m}),” Information and Computation, Vol. 83, pp. 21-40, 1989.
[6] M. A. Hasan, M. Z. Wang, and V. K. Bhargava, “Modular construction of low complexity parallel multipliers for a class of finite fields GF(2^{m}),” IEEE Trans. on Computers vol. 41, no. 8, pp. 962-971, August 1992.
[7] C. K. Koc and B. Sunar, “Low complexity bit-parallel canonical and normal basis multipliers for a class of finite fields,” IEEE Trans. on Computers vol. 47, no. 3, pp. 353-356, March 1998.
[8] H. Wu, and M. A. Hasan, “Low-complexity bit-parallel multipliers for a class of finite fields,” IEEE Trans. on Computers vol. 47, no. 8, pp. 883-887, August 1998.
[9] H. Wu, M. A. Hasan, and L. F. Blake, “New low-complexity bit-parallel finite field multipliers using weakly dual bases,” IEEE Trans. on Computers vol. 47, no. 11, pp. 1223-1234, November 1998.
[10] C. Y. Lee, E. H. Lu, and J. Y Lee, “Bit-Parallel Systolic Multipliers for GF(2^{m}) Fields Defined by All-One and Equally-Spaced Polynomials,” IEEE Trans. on Computers, No. 5, pp. 385-393, May 2001.
[11] C. Y. Lee, E. H. Lu, and J. Y. Lee, “Bit-Parallel Systolic Modular Multipliers for for a class of GF(2^{m}),” 15th IEEE Symposium on Computer Arithmetic (Arith-2001), Vail, Colo., USA, pp. 51-58, June 2001.
[12] EEE-SA Standards Board, “IEEE Std. 1363-2000, IEEE Standard Specifications for Public-Key Cryptography,” January 2000.

What is claimed is:

1. A low complexity bit-parallel systolic architecture for computing C+AB, AB, C+AB² or AB² over a class of GF(2^{m}) free global connection, wherein the A, B and C are the input elements of the GF(2^{m}).

2. The systolic architecture as claimed in claim 1 comprising an inner product unit and a modular arithmetic unit, the inner product unit including m² pieces of U cells and 2 m+1 pieces of latch units, each U cell including a AND gate, an XOR gate and three latches, the coefficients Aⱼ, Bⱼ and C_{<2>} of A, B and C respectively inputted via the input ends Aⱼ, Sⱼ and C_{<2j>} of U_{0,j}, wherein the <2j> represents the 2j modulo m+1, the modular arithmetic unit including m pieces of repulsive XOR gate for computing the modular p(x).

3. The systolic architecture as claimed in claim 1 further comprising an inner product unit, after the inner product unit computing the U cell of the first stratum, the A and B respectively right and left endlessly moved into the cell of the second stratum and running the following formula,
T_{0,j}=C_{<2j>} original value, for j=0, 1 . . . , m.
T_{i+1,j}=T_{i,j}+Aⱼ⁽ⁱ⁾·Bⱼ⁽⁻ⁱ⁾, for i=0, 1 . . . , m, and j=0, 1 . . . , m.
D_{<2j>}=T_{m+1,j}, for j=0, 1 . . . , m.
wherein Aⱼ⁽ⁱ⁾ and Bⱼ⁽⁻ⁱ⁾ respectively represent right Aⱼ coefficient and left Bⱼ coefficient rotating i times, and the <2j> represents 2j modulo m+1.

4. The systolic architecture as claimed in claim 1, wherein the circuit achieves GF(2⁴) and the output D is a result of C+AB that can be easily popularized to a class of GF(2^{m}), wherein the m is a plus integer that is kept in a modular polynomial.

5. The systolic architecture as claimed in claim 1 being used to computing A multiply B when the coefficient of C is zero.

6. The systolic architecture as claimed in claim 1 being used in GF(2^{m}) formed by a modular polynomial for computing C+AB².

7. The systolic architecture as claimed in claim 6 comprising an inner product unit and a modular arithmetic unit, the inner product unit including m² pieces of U cells and 2m+1 pieces of latch units, each U cell including a AND gate, an XOR gate and three latches, the coefficients Aⱼ, Bⱼ and C_{<2j>} of A, B and C respectively inputted via the input ends Aⱼ, Sⱼ and C_{<2j>} of U_{0,j}, wherein the <2j> represents the 2j modulo m+1, the modular arithmetic unit including m XOR gates for computing the modular p(x).

8. The systolic architecture as claimed in claim further comprising an inner product unit, after the inner product unit computing the U cell of the first stratum, the A and B respectively right and left endlessly moved into the cell of the second stratum and running the following formula,
T_{0,j}=C_{<2j>} original value, for j=0, 1 . . . , m.
T_{i+1,j}=T_{i,j}+Aⱼ⁽ⁱ⁾·Bⱼ⁽⁻ⁱ⁾ for i=0, 1 . . . , m, and j=0, 1 . . . , m.
D_{<2j>=T}_{m+1,j}, for j=0, 1 . . . , m.
Wherein Sⱼ=B_{i/2}, for even i, Sⱼ=B_{(i+m+1)/2}, for odd i.

9. The systolic architecture as claimed in claim 6, wherein the circuit achieves GF(2⁴) and the output D is a result of C+AB² that can be easily popularized to a class of GF(2^{m}), wherein the m is a plus integer that is kept in a modular polynomial.

10. The systolic architecture as claimed in claim 6 being used to computing A multiply B² when the coefficient of C is zero.

11. A architecture for computing C+AB over a class of GF(2^{nr}) formed by a all one polynomial, wherein the A, B and C are the input elements of the GF(2^{nr}).

12. The systolic architecture as claimed in claim 11 comprising an inner product unit and a modular arithmetic unit, the inner product unit including (nr)² pieces of U cells and (2n+1)r² pieces of latch units, each U cell including a AND gate, an XOR gate and three latches, the coefficients Aⱼ, Bⱼ and C_{<2j>} of A, B and C respectively inputted via the input ends Aⱼ, Sⱼ and C_{<2j>} of U_{0,j}, wherein the <2j> represents the 2j modulo (n+1)r, the modular arithmetic unit including n*r XOR gates for computing the modular p(x).

13. The systolic architecture as claimed in claim 11 further comprising an inner product unit, after the inner product unit computing the U cell of the first stratum, the A and B respectively right and left endlessly moved into the cell of the second stratum and running the following formula,
T_{,j}=C_{<2j>} original value, for j=0, 1 . . . , (n+1)r−1.
T_{i+1,j}=T_{i,j}+Aⱼ⁽ⁱ⁾·Bⱼ⁽⁻ⁱ⁾, for i=0, 1 . . . , (n+1)r−1, and j=0, 1 . . . , (n+1)r−1.
D_{<2j>}=T_{m+1,j}, for j=0, 1 . . . , (n+1)r−1.
wherein Aⱼ⁽ⁱ⁾ and Bⱼ⁽⁻ⁱ⁾ respectively represent right Aⱼ coefficient and left Bⱼ coefficient rotating i times, and the <2j> represents 2j mold m+1.

14. The systolic architecture as claimed in claim 11, wherein the circuit achieves GF(2⁶) and the output D is a result of C+AB that can be easily popularized to a class of GF(2^{nr}), wherein the nr is a plus integer that is kept in a modular polynomial.

15. The systolic architecture as claimed in claim 11 being used to computing A multiply B when the coefficient of C is zero.

16. A architecture for computing C+AB over a class of GF(2^{nr}) based on an equally spaced polynomial (ESP), wherein the A, B and C are the input elements of the GF(2^{nr}).

17. The systolic architecture as claimed in claim 16 comprising an inner product unit and a modular arithmetic unit, the inner product unit including (nr)² pieces of U cells and (2n+1)r² pieces of latch units, each U cell including an AND gate, an XOR gate and three latches, the coefficients Aⱼ, Bⱼ and C_{<2j>} of A, B and C respectively inputted via the input ends Aⱼ, Sⱼ and C_{<2j>} of U_{0,j}, wherein the <2j> represents the 2j modulo (n+1)r, the modular arithmetic unit including n*r XOR gates for computing the modular p(x).

18. The systolic architecture as claimed in claim 16 further comprising an inner product unit, after the inner product unit computing the U cell of the first stratum, the A and B respectively right and left endlessly moved into the cell of the second stratum and running the following formula,
T_{0,j}=C_{<2j>} original value, for j=0, 1 . . . , (n+1)r−1.
T_{i+1,j}=T_{i,j}^{+A}ⱼ⁽ⁱ⁾·Bⱼ⁽⁻ⁱ⁾, for i=0, 1 . . . , (n+1)r−1, and j=0, 1 . . . , (n+1)r−1.
D_{<2j>}=T_{(n+1)r,j}, for j=0, 1 . . . , (n+1)r−1.
wherein Aⱼ⁽ⁱ⁾ and Bⱼ⁽⁻ⁱ⁾ respectively represent right Aⱼ coefficient and left Bⱼ coefficient rotating i times, and the <2j> represents 2j mold (n+1)r.

19. The systolic architecture as claimed in claim 16, wherein the output D is a result of C+AB that can be easily popularized to a class of GF(2^{nr}) based on ESP, wherein the n and r are integers.

20. The systolic architecture as claimed in claim 16 being used to computing A multiply B when the coefficients of C are zeroes.
